(19) United States
(12) Patent Application Publication
(10) Pub. No.: US 2003/0224173 A1
(43) Pub. Date: Dec. 4, 2003

(54) Polymer-cellulose composites having increased fade resistance and process for producing same

(76) Inventors: Scott Sackinger, Clackamas, OR (US); Jay Tanzer, Clackamas, OR (US)

Correspondence Address: MARGER JOHNSON & MCCOLLOM PC, 1030 SW MORRISON STREET, PORTLAND, OR, 97205, US

(21) Appl. No.: 10/412,735

(22) Filed: Apr. 10, 2003

Related U.S. Application Data
(60) Provisional application No. 60/373,123, filed on Apr. 16, 2002.

(51) Int. Cl. B32B 9/04; B32B 27/00; B32B 23/08; B32B 27/06

(52) U.S. Cl. 428/411.1; 428/500; 428/507

(57) ABSTRACT

Excellent fade resistance and a substantial reduction in whitening can unexpectedly be achieved by adding colorant pigments to polymer-cellulose materials which form the polymer-wood composites, prior to formation of the composites. Then, the outer surface of the polymer-wood composites including the colorant pigments are distressed. The addition of the colorant pigments to the polymer-cellulose materials, combined with the distressing of the surface of the composites formed therefrom, results in an unexpected reduction in the unacceptable level of whitening and/or fading mentioned above which has not taken place in polymer-wood composites which include either a per se colorant pigment addition or which have been subject to a per se surface distressing operation.

### RELATED PATENT APPLICATION

This application claims the benefit of U.S. Provisional Application No. 60/373,123, filed Apr. 16, 2002.

### BACKGROUND OF THE INVENTION

Polymer-cellulose composites are known. For example, U.S. Pat. No. 6,337,138 (“U.S. Pat. No. '138”) relates to a cellulosic, inorganic-filled plastic composite comprising cellulosic material, talc and polyethylene.

Polymer-wood composites for exterior applications, such those described in U.S. Pat. No. '138, are susceptible to whitening when exposed to the sun. Traditional UV screeners and antioxidants are expensive and, when used at economical concentrations, are not effective at reducing this whitening effect. Pigments per se can be added to the wood composite during the formation of the polymer-wood composite. For purposes of expediency, U.S. Pat. No. '138 is incorporated herein by reference.

### DESCRIPTION OF THE DRAWINGS

FIG. 1 is a photograph which visually shows the dramatic effect of the invention on fade resistance of samples 4-4-1 through 4-4-5, as measured after accelerated exposure (490 hours) in the QUV cyclic UV/water spray apparatus.

### SUMMARY OF THE INVENTION

The addition of pigments to polymer-wood composites in general is known. The addition of pigments alone can increase fade resistance, but only moderately. Similarly, distressing or brushing per se of the surface of a non-pigmented composite is insufficient to prevent excessive fading.

It has now been found that excellent fade resistance and a substantial reduction in whitening can unexpectedly be achieved by adding colorant pigments to polymer-cellulose materials which form the polymer-wood composites, prior to formation of the composites. Then, the outer surfaces of the polymer-wood composites including the colorant pigments are distressed. The addition of the colorant pigments to the polymer-cellulose materials, combined with the distressing of the surface of the composites formed therefrom, results in an unexpected reduction in the unacceptable level of whitening and/or fading mentioned above which has not taken place in polymer-wood composites which include either a per se colorant pigment addition or which have been subject to a per se surface distressing operation.

More specifically, a method for producing a polymer-cellulose composite having increased fade resistance is provided. The method comprises providing a substantially undistressed polymer-cellulose composite. The composite comprises cellulose material, a polymer, and a colorant pigment, preferably a stable colorant pigment, and more preferably a light-stable colorant pigment. An outer surface of the substantially undistressed polymer-cellulose composite is treated so that it is substantially distressed. A polymer-cellulose composite is then formed having increased fade resistance. More specifically, the polymer-cellulose composite of the present invention having a substantially distressed outer surface exhibits a substantially increased level of fade resistance than a comparable polymer-cellulose composite which does not have a substantially distressed outer surface. This can be readily determined by visual inspection of the respective polymer-cellulose composites after significant exposure to light in laboratory chambers or outdoors.

The polymer of the present invention forms a composite structure in combination with the cellulose material. Preferably, the polymer employed in the polymer-cellulose composite is polyethylene, polypropylene, polyvinyl chloride, or combinations thereof. High-density polyethylene is the most preferred polymer constituent.

The cellulose material can be cellulose particles such as wood fibers, wood chips, sawdust, comminuted wood, wood flour, rice hulls, nut shells, etc. The cellulose material to polymer weight ratio of the polymer-cellulose composite is preferably from about 20% to 80% up to about 70% to 30%, more preferably from about 25% to 75% up to about 65% to 35%, and most preferably from about 30% to 70% up to about 60% to 40%.

Various methods of addition of the colorant pigment may be employed. In a preferred process of the present invention, powdered and/or pelletized colorant pigments, or colorant pigments which are powdered concentrates, are pre-blended in dry form with the polymeric compound prior to extrusion of the polymer-cellulose composite. Alternatively, the aforementioned powders and/or pelletized pigments may be added at the head of the extruder.

This product is a polymer-wood composite with light stable pigments capable of producing the full range of colors desired for specified end-uses, such as exterior decking. Preferably, iron oxide pigments, such as light-stable iron oxide pigments, are employed for this purpose. Examples of the colorant pigment which can be employed in this invention include Bayer products such as the following Bayferrox colorant pigments: Yellow 415, Reds 105M, 110M, 140M, 160M, and Brown 645T. Organic pigments which may also be preferably used are lightfast compounds including several of Bayer's quinacridone products such as BayPlast 2B, Magenta B, and Violet R. Other pigments such as titanium dioxide and carbon black may be blended along with the aforementioned colorant pigments to modify shades as desired.

In a further preferred form of the present invention, the undistressed polymer-cellulose composite has a glossy outer surface as produced, such as by extrusion. A substantially distressed outer surface is formed by applying sufficient force to the undistressed polymer-cellulose composite to disrupt this glossy outer surface. The substantially distressed outer surface of the polymer-cellulose composite is preferably a partially-opacified, disrupted outer surface. More preferably, the substantially distressed outer surface is a partially-opacified, brushed outer surface. Moreover, the polymer-cellulose composite of this invention comprises a substantially distressed outer surface having a substantially higher level of scratch resistance than a comparable polymer-cellulose composite which does not have a substantially distressed outer surface. The distressing of the outer surface can be readily ascertained by visual inspection of the respective polymer-cellulose composites.

Distressing of the surface of the polymer-cellulose composites can be carried out using any of several commercially available processes to develop a wide range of surface disrupting effects. For example, the surface may be dry or wet blasted using glass beads or aluminum oxide grits to provide a smooth appearance. Furthermore, rotating wire brushes or scrapers may be employed to impart shallow grooves to the composite surface, thus forming grain effects therein. In a preferred embodiment, a steel wire brush machine manufactured by Industrial Brush Co., Inc. of Fairfield N.J. is used to provide a distressed pattern consisting of variable shallow grooves. Distressing may be applied to one or both surfaces, as well as to the sides of the composite structure, depending on intended usage. The composite may be designed for reversibility, thus a different distressing pattern may be used on each major surface to increase user flexibility.

Specifically, the subject polymer-cellulose composite having a substantially distressed outer surface has a substantially increased level of fade resistance than a polymer-cellulose composite having a substantially distressed outer surface but which does not include a colorant pigment. Furthermore, the polymer-cellulose composite of this invention, which has a substantially distressed outer surface, has a substantially increased level of fade resistance than a comparable polymer-cellulose composite which does not have a substantially distressed outer surface. Again, this can be confirmed by visual inspection of the respective polymer-cellulose composites after significant exposure to light in laboratory chambers or outdoors.

“Fade Resistance”, for purposes this invention, can also be analytically determined employing the “L” Value of a polymer-cellulose composite. “Fade Resistance” can be calculated by (a) computing the net % increase in the hereafter described “L” Value, measured before exposure and after exposure, of a given polymer-cellulose composite, and (b) subtracting the net % increase in the hereafter described “L” Value from 100%. For example, a pigmented redwood sample which is hereinafter set forth in Table I has an “L” Value before exposure of 48.7 and an “L” Value after exposure of 49.4. Therefore, the net % increase in the “L” Value after exposure, as compared to the “L” Value before exposure, is 1.4%. Subtracting the net % increase in the “L” Value of 1.4% from 100% results in a Fade Resistance which has a value of 98.6%.

The polymer-cellulose composite of this invention which includes a colorant pigment and has a substantially distressed outer surface exhibits a Fade Resistance which is preferably not less than about 85%, more preferably not less than about 90%, and most preferably not more than about 95%.

Substantial increase in fade resistance of the subject polymer-cellulose composite, after accelerated exposure, can also be determined by visual inspection thereof. The term “accelerated exposure” relates to subjecting a polymer-cellulose composite to the decolorizing effect of UV light in conjunction with aqueous spraying as hereinafter described. In this case, “accelerated exposure” was conducted for an extended time period (490 hours) in a QUV cyclic UV/water spray apparatus. The subject accelerated exposure apparatus subjects a sample to continuous, alternating cycles of UV exposure, water spray, and water condensation.

Preferably, any significant amount of fading of a polymer-cellulose composite produced by the present invention, measured after accelerated exposure, has been considerably reduced, and more preferably substantially eliminated. This has been corroborated by visual inspection of the composite samples after accelerated exposure. A polymer-cellulose composite including a colorant pigment as described above, but which does not have a distressed outer surface, will visually exhibit significant fading on accelerated exposure (especially in lighter shades of color). In the case of a polymer-cellulose composite which does have a distressed outer surface, but which does not include a colorant pigment as described above, on visual inspection, will have significant fading after accelerated exposure. In contrast, a polymer-cellulose composite including a light stable oxide pigment which has a distressed outer surface visually shows essentially no fading when accelerated exposure has been completed.

### DETAILED DESCRIPTION OF A PREFERRED EMBODIMENT

The attached data illustrates results achieved using the teaching of the present invention. These results have been compared to other methods which are outside the scope of this invention. More specifically, tests were conducted on polymer-cellulose composites (“PCC”) some of which included various colorant pigments. The outer surface of some of these composites was distressed.

The PCC composition tested was approximately 60% wood fiber and 40% high-density polyethylene, with some minor additives. These additives included about 5% talc, 2% phenol-formaldehyde resin, and 4% lubricants such as zinc stearate/EBS wax. The wood fiber was in the form of wood flour that was dried to approximately a 1% MC. Pigments were added either as dry powders during pre-blending. Extrusion was carried out using a 27-mm Leistritz twin-screw extruder. The respective Extruder barrel and die temperatures were 170 and 200 degrees C. The vacuum was set at 950 mm of Hg. The screws were turned counterclockwise at 50 rpm and melt pressure ranged 900-1100 for all items. The feed rate was 0.26 lbs/min and the residence time was 2.74 minutes. A billet 0.25″ thick by 1″ width was extruded at a linear speed of about 2 ft./minute.

Experiments were conducted to demonstrate the effect on fading of a composite formed from a PCC composition including a series of iron oxide colorant pigments. Composite colors of redwood, cedar, madeira, tan and gray were made by dry blending of iron oxide colorant pigments obtained from Hansen Engineering, Inc., West Alexander, Pa., with the above described PCC composition. These are represented by the experimental 4-4-x series shown in Table I.

An alternate method of pigment addition can also be used. Polymer/pigment pellets, typically in concentrate form, can be fed in at the head of the extruder rather than pre-blended. The pellet feed method generally employs two pellet feed streams which are introduced to separate feeders of a Twin Screw Extruder. A dry pre-blend of one feeder would contain a portion of the normal amount of pellets. The other feeder would contain the remainder of the pellets at a ratio to match the desired pellet feed rate.

Typically, distressing means applying sufficient force to disrupt the normally glossy surface of the PCC composition, and to substantially opacify it. In this case, distressing in the form of brushing was accomplished by hand using a wire brush.

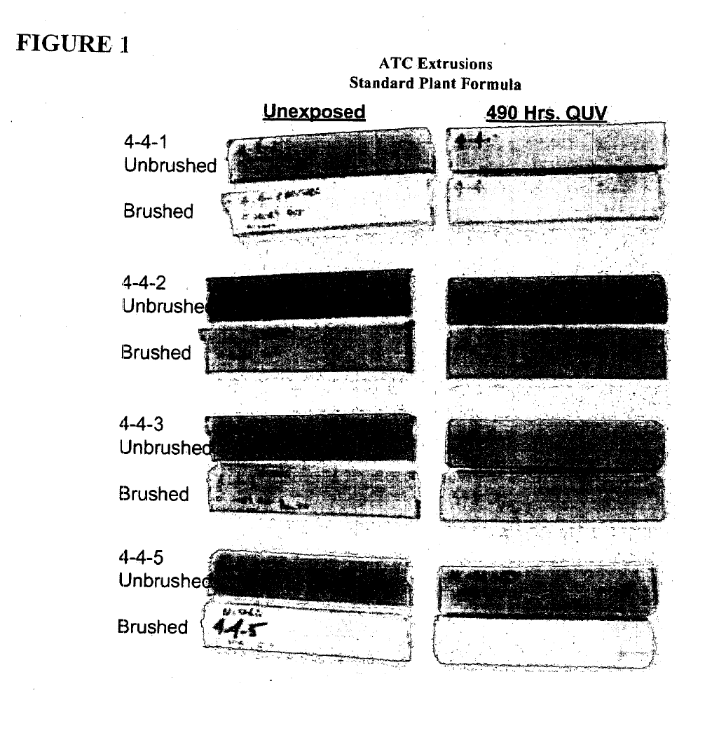

The test data in Table 2 evidences the benefits of combining the distressing of the composite surface (brushing) with the use of colorant (iron oxide) pigments in the composite composition to achieve surprisingly good fade resistance. The first photo attachment, FIG. 1, visually shows the dramatic effect of the invention on fade resistance of samples 4-4-1 through 4-4-5, as measured after accelerated exposure (490 hours) in the QUV cyclic UV/water spray apparatus. The unbrushed samples show moderate fading of the iron oxide pigments. After brushing, however, fading has been substantially completely eliminated.

TABLE 1

| | Composite Color | % Colorant Pigment |
|---|---|---|
| 4-4-1 | Cedar | 2.7% # 592 Yellow + 0.15% #120 Red + |
| | | 0.3% #723 black |
| 4-4-2 | Madeira | 3.0% # 963 Brown |
| 4-4-3 | Redwood | 3.0% # 910 Brown |
| 4-4-4 | Tan | 2.0% # 592 Yellow |
| 4-4-5 | Gray | 0.5% # 723 Black |

TABLE 2
Fade Resistance L Values-Laboratory Samples

| | | Before | | After | | % Fade | |
|---|---|---|---|---|---|---|---|
| | | Exposure | | Exposure | | Resistance | |
| | | As-is | Brushed | As-is | Brushed | As-is | Brushed |
| 4-4-1 | Cedar | 42.7 | 55.0 | 54.3 | 55.6 | 78.6 | 98.9 |
| 4-4-2 | Madeira | 30.6 | 43.5 | 37.7 | 40.3 | 81.2 | 100* |
| 4-4-3 | Redwood | 34.7 | 46.2 | 45.7 | 47.2 | 75.9 | 97.9 |
| 4-4-4 | Tan | 54.2 | 58.2 | 63.5 | 65.8 | 85.4 | 88.4 |
| 4-4-5 | Gray | 33.9 | 50.8 | 55.9 | 57.7 | 60.6 | 88.0 |

*sample turned slightly darker

An unexpected increase has been achieved in the level of fade resistance mentioned above with respect to polymer-wood composites which have undergone both colorant pigment addition and a surface distressing operation as contrasted with polymer-wood composites which have not undergone both colorant pigment addition and a surface distressing operation.

The attached data illustrates results achieved using the teaching of the present invention.

Improvements in fade resistance were measured using a QUV/spray apparatus manufactured by Q-Panel Lab Products, Cleveland, Ohio. Samples were subjected to alternating cycles of UV exposure, water spray, and water condensation. Light intensity for UV exposure was about 1.0 watts/sq. meter/at 340 nm wavelength.

Commercially produced samples of unpigmented decking and others pigmented with fade-resistant iron oxides to gray, cedar, and redwood shades, were exposed for 3262 hours. A Greta-MacBeth Colorimeter was used to measure color changes.

The “L” scale values denote the overall depth of shade. Increasing “L” indicates a lightening or fading of the shade. In Table 3, the unpigmented control shows extreme fading. Visually this represents a change from a light tan, natural wood color to milk-white. Thus, brushing alone does not solve the fading problem. Unexpectedly, the combination of pigmenting the sampling with brushing provides the best fading resistance.

TABLE 3
Fade Resistance-“L” Values of Commercial Samples

| | “L” Value Be- | | | | |
|---|---|---|---|---|---|
| | fore Exposure | | “L” Values After Exposure | | |
| | As-is | Brushed | Brushed | % Increase | Fade Resistance |
| Un | 60.0 | 66.0 | 82.9 | 25.6 | 74.4 |
| pigmented | | | | | |
| Pigmented | 55.5 | 56.4 | 60.1 | 6.6 | 93.4 |
| Cedar | | | | | |
| Pigmented | 52.0 | 54.1 | 55.9 | 3.3 | 96.7 |
| Gray | | | | | |
| Pigmented | 40.5 | 48.7 | 49.4 | 1.4 | 98.6 |
| Redwood | | | | | |

Having described and illustrated the principles the invention in a preferred embodiment thereof, it should be apparent that the invention could be modified in arrangement and detail without departing from such principles. (We) claim all modifications and variations coming within the spirit and scope of the following claims.

We claim:

1. A polymer-cellulose composite having enhanced whitening reduction and/or fade resistance, which comprises:
a polymeric material;
a cellulose material; and
a colorant pigment,
the composite having one or more outer surfaces which are substantially distressed, said substantially distressed outer surfaces having a substantially increased level of fade resistance than a comparable polymer-cellulose composite which does not have substantially distressed outer surfaces.

2. The composite of claim 1, wherein the polymeric material is polyethylene, polypropylene, polyvinyl chloride, or combinations thereof.

3. The composite of claim 1, wherein the colorant pigment is an iron oxide pigment.

4. The composite of claim 1, wherein the substantially distressed outer surface is a partially-opacified, substantially disrupted outer surface.

5. The composite of claim 4, wherein the substantially distressed outer surface is a partially-opacified, brushed outer surface.

6. The composite of claim 1, wherein the cellulose material to polymer weight ratio is from about 20% to 80% up to about 70% to 30%.

7. The composite of claim 1, wherein said polymer-cellulose composite has a substantially distressed outer surface having a substantially reduced level of whitening than a comparable polymer-cellulose composite which does not have a substantially distressed outer surface.

8. The composite of claim 1, wherein said polymer-cellulose composite has a substantially distressed outer surface exhibits a level of fade resistance which is at least about 85%.

9. The composite of claim 1, wherein said colorant pigment is stable.

10. The composite of claim 1, wherein said colorant pigment is light stable.

11. A method for producing a polymer-cellulose composite having enhanced whitening reduction and/or fade resistance, which comprises:
providing a substantially undistressed polymer-cellulose composite comprising cellulose material, a polymer, and a colorant pigment; and
treating an outer surface of the substantially undistressed polymer-cellulose composite so that it is substantially distressed, said substantially distressed outer surface having a substantially increased level of fade resistance than a comparable polymer-cellulose composite which does not have a substantially distressed outer surface.

12. The method of claim 11, wherein the polymeric material is polyethylene, polypropylene, polyvinyl chloride, or combinations thereof.

13. The method of claim 11, wherein the colorant pigment is an iron oxide pigment.

14. The method of claim 11, wherein the substantially distressed outer surface is a partially-opacified, substantially disrupted outer surface.

15. The method of claim 14, wherein the substantially distressed outer surface is a partially-opacified, brushed outer surface.

16. The method of claim 11, wherein the cellulose material to polymer weight ratio is from about 20% to 80% up to about 70% to 30%.

17. The method of claim 11, wherein said polymer-cellulose composite has a substantially distressed outer surface having a substantially reduced level of whitening than a comparable polymer-cellulose composite which does not have a substantially distressed outer surface.

18. The method of claim 11, wherein said polymer-cellulose composite has a substantially distressed outer surface exhibits a level of fade resistance which is at least about 85%.

19. The method of claim 11, wherein said colorant pigment is stable.

20. The method of claim 11, wherein said colorant pigment is light stable.

21. A method for producing a polymer-cellulose composite having enhanced whitening reduction and/or fade resistance, which comprises:
providing a substantially undistressed polymer-cellulose composite comprising cellulose material, a polymer, and a stable colorant pigment, the cellulose material to polymer weight ratio being from about 20% to 80% up to about 70% to 30%; and
treating an outer surface of the substantially undistressed polymer-cellulose composite so that it is distressed, said polymer-cellulose composite having a substantially a fade resistance which is at least about 85%.
